(19) United States
(12) Patent Application Publication
(10) Pub. No.: US 2014/0188561 A1
(43) Pub. Date: Jul. 3, 2014

(54) Audience Measurement System, Method and Apparatus with Grip Sensing

(71) Applicant: Arbitron Inc., Columbia, MD (US)

(72) Inventors: Michael Tenbrock, Columbia, MD (US); William McKenna, Columbia, MD (US)

(21) Appl. No.: 13/729,700

(22) Filed: Dec. 28, 2012

(51) Int. Cl. G06Q 30/02

(52) U.S. Cl. CPC G06Q 30/0203
USPC 705/7.32

(57) ABSTRACT

A system, apparatus and method for determining grip sensing for a portable device that is configured to produce media exposure data. At least one sensor associated with a portable device produces sensed grip readings representing a manner in which the device was grasped. The sensed grip readings may be processed to determine a manner of usage or a user identity. Additional sensor readings, such as touch screen readings and accelerometer readings may be combined with the grip sensing. The sensor data may be combined with the media exposure data for report generation for audience measurement purposes.

### TECHNICAL FIELD

The present disclosure is directed to portable devices configured to engage in audience measurement. More specifically, the present disclosure is directed to detecting media exposure data and grip sensing of the portable device.

### BACKGROUND INFORMATION

The recent surge in popularity of touch screen phones and tablet-based computer processing devices, such as the iPad™, Xoom™, Galaxy Tab™ and Playbook™ has spurred new dimensions of personal computing. The touch screen enables persons to interact directly with what is displayed, rather than indirectly with a pointer controlled by a mouse or touchpad. Furthermore, touch screens allow people to interact with the computer without requiring any intermediate device that would need to be held in the hand. The touch screen displays can be attached to computers, or to networks as terminals and play a prominent role in the design of digital appliances such as the personal digital assistant (PDA), satellite navigation devices, mobile phones, and video games.

In addition to personal computing, the portability of touch screen devices makes them good candidates for audience measurement purposes. In addition to measuring on-line media usage, such as web pages, programs and files, touch screen devices are particularly suited for surveys and questionnaires. Furthermore, by utilizing specialized microphones, touch screen devices may be used for monitoring user exposure to media data, such as radio and television broadcasts, streaming audio and/or video, billboards, products, and so one. Some examples of such applications are described in U.S. patent application Ser. No. 12/246,225, titled “Gathering Research Data” to Joan Fitzgerald et al., U.S. patent application Ser. No. 11/643,128, titled “Methods and Systems for Conducting Research Operations” to Gopalakrishnan et al., U.S. patent application Ser. No. 11/643,360, titled “Methods and Systems for Conducting Research Operations” to Flanagan, III et al., U.S. patent application Ser. No. 13/307,599 titled “Tactile and Gestational Identification and Linking to media Consumption” to Stavropolous, et al., filed Nov. 30, 2011, each of which are assigned to the assignee of the present application and are incorporated by reference in their entirety herein.

Recently, grip sensing technology has garnered considerable interest in the field of mobile technology, and cell phone manufacturers have incorporated certain sensing to determining user hand grip orientation. Examples include U.S. patent application Ser. No. 12/638,507 to Baek et al., titled “Method and Apparatus for Sensing Grip on Mobile Terminal”, filed Dec., 15, 2009, U.S. patent application Ser. No. 12/205,430, to Pratt et al., titled “User Identification in Cell Phones Based on Skin Contact”, filed Sep. 5, 2008, U.S. patent application Ser. No. 10/798,240 to Carter et al., titled “Method of Determining Orientation and Manner of holding a Mobile Telephone,” filed Mar. 11, 2004, U.S. Pat. No. 8,055,305 to Cho et al., titled “Method and Apparatus for Inputting Function of Mobile Terminal Using User's Grip Posture While Holding Mobile Terminal,” issued Nov. 8, 2011, and WIPO Int'l Pub. No. WO 2010/005185, to Park et al., titled “Method and Apparatus to Use a User Interface,” filed Jun. 18, 2009. Each of these is incorporated by reference in their entireties herein.

However, one drawback of existing grip detection is that entities looking to use the technology are limited to that which cell phone manufacturers provide. Thus, customized applications are difficult to implement. Furthermore, the grip sensing does not incorporate aspects of audience measurement technology that allows it to be combined with processor-based media exposure measurement. Grip sensing and detection would be an advantageous feature to incorporate into such applications, particularly when it may be combined with other areas of sensing, such as touch screens, gyroscopes and accelerometer.

### SUMMARY

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The terms “media data” and “media” as used herein mean data which is widely accessible, whether over-the-air, or via cable, satellite, network, internetwork (including the Internet), print, displayed, distributed on storage media, or by any other means or technique that is humanly perceptible, without regard to the form or content of such data, and including but not limited to audio, video, audio/video, text, images, animations, databases, broadcasts, signals, web pages, print media and streaming media data.

The term “research data” or “media exposure data” as used herein means data comprising (1) data concerning usage of media data, (2) data concerning exposure to media data, and/or (3) market research data.

The term “presentation data” as used herein means media data or content other than media data to be presented to a user.

The term “ancillary code” as used herein means data encoded in, added to, combined with or embedded in media data to provide information identifying, describing and/or characterizing the media data, and/or other information useful as research data.

The terms “reading” and “read” as used herein mean a process or processes that serve to recover research data that has been added to, encoded in, combined with or embedded in, media data.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, function, activity or thing from another, and are not used to designate relative position, or arrangement in time or relative importance, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

Accordingly, under one exemplary embodiment, a computer-implemented method for processing sensor data for the purposes of audience measurement is disclosed. The method comprises the steps of: receiving in a processing device first sensor data, said first sensor data comprising grip data relating to contact with a first sensor associated with a portable device; receiving in the processing device media exposure data, said media exposure data representing media received or reproduced on the portable device; and processing the first sensor data to determine a characteristic of the grip data, wherein the characteristic relates to a manner in which the first sensor was grasped. The characteristic may comprise a mode of usage or grip data associated with a specific user that may be subsequently validated. Other sensor data, comprising touch screen and accelerometer data may be combined with the grip sensor data. The media exposure data comprises at least one of ancillary codes from audio, audio signatures, metadata, software data and application data.

Under another exemplary embodiment, a system is disclosed for processing sensor data in a portable device for the purposes of audience measurement. The system comprises a processor and a first sensor, operatively coupled to the processor, wherein the first sensor is configured to produce first sensor data, and the first sensor data comprising grip data relating to contact with the first sensor associated with the portable device. The processor is configured to produce media exposure data, wherein the media exposure data represents media received or reproduced on the portable device. The processor is also configured to process the first sensor data to determine a characteristic of the grip data, wherein the characteristic relates to a manner in which the first sensor was grasped. The characteristic may comprise a mode of usage or grip data associated with a specific user that may be subsequently validated. Other sensor data, comprising touch screen and accelerometer data may be combined with the grip sensor data. The media exposure data comprises at least one of ancillary codes from audio, audio signatures, metadata, software data and application data.

### BRIEF DESCRIPTION OF THE DRAWINGS

The present invention is illustrated by way of example and not limitation in the figures of the accompanying drawings, in which like references indicate similar elements and in which:

FIG. 1 is an exemplary touch screen processing device configured to register touch profiles, data usage and/or media exposure under an exemplary embodiment;

FIG. 2 illustrates an exemplary configuration for registering touches on a portable device;

FIG. 3 illustrates an exemplary hardware configuration for registering touches in the embodiment of FIG. 2;

FIGS. 4A and 4B illustrate exemplary embodiments for grip sensing enclosures under one embodiment;

FIGS. 5A-C illustrate various sensor configurations for grip sensing under other embodiments;

FIG. 6 illustrates an exemplary hardware configuration for grip sensing;

FIGS. 7A-F illustrate various exemplary grip configurations that may be sensed utilizing the embodiments described above;

FIG. 8 illustrates an exemplary flowchart for grip sensing and processing in conjunction with other sensed features; and

FIG. 9 illustrates an exemplary process for incorporating grip sensing and other sensing with media exposure measurement under one embodiment.

### DETAILED DESCRIPTION

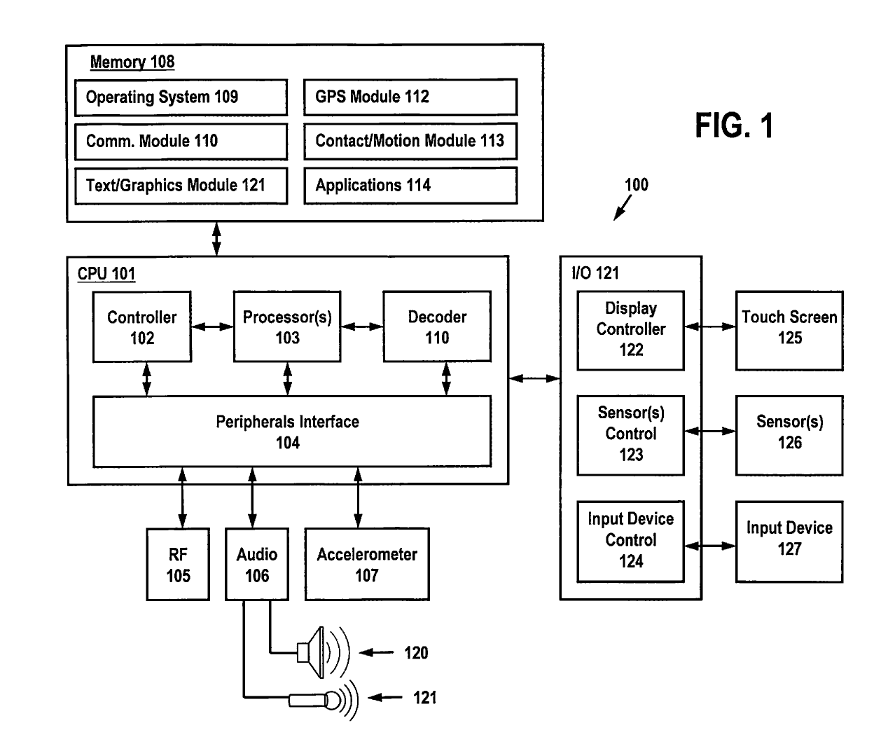

FIG. 1 is an exemplary embodiment of a touch-screen processing device 100, which may be a smart phone, tablet computer, or the like. Device 100 may include a central processing unit (CPU) 101 (which may include one or more computer readable storage mediums), a memory controller 102, one or more processors 103, a peripherals interface 104, RF circuitry 105, audio circuitry 106, a speaker 120, a microphone 120, and an input/output (I/O) subsystem 111 having display controller 112, control circuitry for one or more sensors 113 and input device control 114. These components may communicate over one or more communication buses or signal lines in device 100. It should be appreciated that device 100 is only one example of a portable multifunction device 100, and that device 100 may have more or fewer components than shown, may combine two or more components, or a may have a different configuration or arrangement of the components. The various components shown in FIG. 1 may be implemented in hardware, software or a combination of hardware and software (i.e., embodied in a tangible medium), including one or more signal processing and/or application specific integrated circuits.

Decoder 110 serves to process audio and/or decode ancillary data embedded in audio signals in order to detect exposure to media. Examples of techniques for encoding and decoding such ancillary data are disclosed in U.S. Pat. No. 6,871,180, titled “Decoding of Information in Audio Signals,” issued Mar. 22, 2005, which is assigned to the assignee of the present application, and is incorporated by reference in its entirety herein. Other suitable techniques for encoding data in audio data are disclosed in U.S. Pat. No. 7,640,141 to Ronald S. Kolessar and U.S. Pat. No. 5,764,763 to James M. Jensen, et al., which is also assigned to the assignee of the present application, and which are incorporated by reference in their entirety herein. Other appropriate encoding techniques are disclosed in U.S. Pat. No. 5,579,124 to Aijala, et al., U.S. Pat. Nos. 5,574,962, 5,581,800 and 5,787,334 to Fardeau, et al., and U.S. Pat. No. 5,450,490 to Jensen, et al., each of which is assigned to the assignee of the present application and all of which are incorporated herein by reference in their entirety.

An audio signal which may be encoded with a plurality of code symbols is received at microphone 121, or via a direct link through audio circuitry 106. The received audio signal may be from streaming media, broadcast, otherwise communicated signal, or a signal reproduced from storage in a device. It may be a direct coupled or an acoustically coupled signal. From the following description in connection with the accompanying drawings, it will be appreciated that decoder 110 is capable of detecting codes in addition to those arranged in the formats disclosed hereinabove.

For received audio signals in the time domain, decoder 110 transforms such signals to the frequency domain preferably through a fast Fourier transform (FFT) although a direct cosine transform, a chirp transform or a Winograd transform algorithm (WFTA) may be employed in the alternative. Any other time-to-frequency-domain transformation function providing the necessary resolution may be employed in place of these. It will be appreciated that in certain implementations, transformation may also be carried out by filters, by an application specific integrated circuit, or any other suitable device or combination of devices. The decoding may also be implemented by one or more devices which also implement one or more of the remaining functions illustrated in FIG. 1.

The frequency domain-converted audio signals are processed in a symbol values derivation function to produce a stream of symbol values for each code symbol included in the received audio signal. The produced symbol values may represent, for example, signal energy, power, sound pressure level, amplitude, etc., measured instantaneously or over a period of time, on an absolute or relative scale, and may be expressed as a single value or as multiple values. Where the symbols are encoded as groups of single frequency components each having a predetermined frequency, the symbol values preferably represent either single frequency component values or one or more values based on single frequency component values.

The streams of symbol values are accumulated over time in an appropriate storage device (e.g., memory 108) on a symbol-by-symbol basis. This configuration is advantageous for use in decoding encoded symbols which repeat periodically, by periodically accumulating symbol values for the various possible symbols. For example, if a given symbol is expected to recur every X seconds, a stream of symbol values may be stored for a period of nX seconds (n>1), and added to the stored values of one or more symbol value streams of nX seconds duration, so that peak symbol values accumulate over time, improving the signal-to-noise ratio of the stored values. The accumulated symbol values are then examined to detect the presence of an encoded message wherein a detected message is output as a result. This function can be carried out by matching the stored accumulated values or a processed version of such values, against stored patterns, whether by correlation or by another pattern matching technique. However, this process is preferably carried out by examining peak accumulated symbol values and their relative timing, to reconstruct their encoded message. This process may be carried out after the first stream of symbol values has been stored and/or after each subsequent stream has been added thereto, so that the message is detected once the signal-to-noise ratios of the stored, accumulated streams of symbol values reveal a valid message pattern.

Alternately or in addition, processor(s) 103 can processes the frequency-domain audio data to extract a signature therefrom, i.e., data expressing information inherent to an audio signal, for use in identifying the audio signal or obtaining other information concerning the audio signal (such as a source or distribution path thereof). Suitable techniques for extracting signatures include those disclosed in U.S. Pat. No. 5,612,729 to Ellis, et al. and in U.S. Pat. No. 4,739,398 to Thomas, et al., both of which are incorporated herein by reference in their entireties. Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel, PCT Publication WO/2002/11123 to Wang, et al. and PCT publication WO/2003/091990 to Wang, et al., all of which are incorporated herein by reference in their entireties. The signature extraction may serve to identify and determine media exposure for the user of a device. Audio signatures may be taken from the frequency domain, the time domain, or a combination of both.

Memory 108 may include high-speed random access memory (RAM) and may also include non-volatile memory, such as one or more magnetic disk storage devices, flash memory devices, or other non-volatile solid-state memory devices. Access to memory 108 by other components of the device 100, such as processor 103, decoder 110 and peripherals interface 104, may be controlled by the memory controller 102. Peripherals interface 104 couples the input and output peripherals of the device to the processor 103 and memory 108. The one or more processors 103 run or execute various software programs and/or sets of instructions stored in memory 108 to perform various functions for the device 100 and to process data. In some embodiments, the peripherals interface 404, processor(s) 103, decoder 110 and memory controller 102 may be implemented on a single chip, such as a chip 101. In some other embodiments, they may be implemented on separate chips.

The RF (radio frequency) circuitry 105 receives and sends RF signals, also called electromagnetic signals. The RF circuitry 105 converts electrical signals to/from electromagnetic signals and communicates with communications networks and other communications devices via the electromagnetic signals. The RF circuitry 105 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 105 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Audio circuitry 106, speaker 120, and microphone 121 provide an audio interface between a user and the device 100. Audio circuitry 406 may receive audio data from the peripherals interface 104, converts the audio data to an electrical signal, and transmits the electrical signal to speaker 120. The speaker 120 converts the electrical signal to human-audible sound waves. Audio circuitry 406 also receives electrical signals converted by the microphone 121 from sound waves, which may include encoded audio, described above. The audio circuitry 106 converts the electrical signal to audio data and transmits the audio data to the peripherals interface 104 for processing. Audio data may be retrieved from and/or transmitted to memory 108 and/or the RF circuitry 105 by peripherals interface 104. In some embodiments, audio circuitry 106 also includes a headset jack for providing an interface between the audio circuitry 106 and removable audio input/output peripherals, such as output-only headphones or a headset with both output (e.g., a headphone for one or both ears) and input (e.g., a microphone).

I/O subsystem 121 couples input/output peripherals on the device 100, such as touch screen 125 and other input/control devices 127, to the peripherals interface 104. The I/O subsystem 121 may include a display controller 122 and one or more input controllers 124 for other input or control devices. The one or more input controllers 124 receive/send electrical signals from/to other input or control devices 127. The other input/control devices 127 may include physical buttons (e.g., push buttons, rocker buttons, etc.), dials, slider switches, joysticks, click wheels, and so forth. In some alternate embodiments, input controller(s) 124 may be coupled to any (or none) of the following: a keyboard, infrared port, USB port, and a pointer device such as a mouse, an up/down button for volume control of the speaker 120 and/or the microphone 121. Touch screen 125 may also be used to implement virtual or soft buttons and one or more soft keyboards.

Touch screen 125 provides an input interface and an output interface between the device and a user. The display controller 122 receives and/or sends electrical signals from/to the touch screen 125. Touch screen 125 displays visual output to the user. The visual output may include graphics, text, icons, video, and any combination thereof (collectively termed “graphics”). In some embodiments, some or all of the visual output may correspond to user-interface objects, further details of which are described below. As describe above, touch screen 125 has a touch-sensitive surface, sensor or set of sensors that accepts input from the user based on haptic and/or tactile contact. Touch screen 125 and display controller 122 (along with any associated modules and/or sets of instructions in memory 108) detect contact (and any movement or breaking of the contact) on the touch screen 115 and converts the detected contact into interaction with user-interface objects (e.g., one or more soft keys, icons, web pages or images) that are displayed on the touch screen. In an exemplary embodiment, a point of contact between a touch screen 415 and the user corresponds to a finger of the user. Touch screen 125 may use LCD (liquid crystal display) technology, or LPD (light emitting polymer display) technology, although other display technologies may be used in other embodiments. Touch screen 125 and display controller 122 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 125.

Device 100 may also include one or more sensors 126 such as optical sensors that comprise charge-coupled device (CCD) or complementary metal-oxide semiconductor (CMOS) phototransistors. The optical sensor may capture still images or video, where the sensor is operated in conjunction with touch screen display 125. Sensors 126 also and preferably include gyroscope sensors, for sensing device orientation, and grip sensors, described in greater detail below. The sensors may be embodied within device 100, or located externally to device 100, while communicating sensor readings to I/O 121.

Device 100 may also include one or more accelerometers 107, which may be operatively coupled to peripherals interface 104. Alternately, the accelerometer 107 may be coupled to an input controller 114 in the I/O subsystem 111. In some embodiments, information displayed on the touch screen display may be altered (e.g., portrait view, landscape view) based on an analysis of data received from the one or more accelerometers and/or gyroscopes.

In some embodiments, the software components stored in memory 108 may include an operating system 109, a communication module 110, a contact/motion module 113, a text/graphics module 111, a Global Positioning System (GPS) module 112, and applications 114. Operating system 109 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components. Communication module 110 facilitates communication with other devices over one or more external ports and also includes various software components for handling data received by the RF circuitry 105. An external port (e.g., Universal Serial Bus (USB), FIREWIRE, etc.) may be provided and adapted for coupling directly to other devices or indirectly over a network (e.g., the Internet, wireless LAN, etc.

Contact/motion module 113 may detect contact with the touch screen 115 (in conjunction with the display controller 112) and other touch sensitive devices (e.g., a touchpad or physical click wheel). The contact/motion module 113 includes various software components for performing various operations related to detection of contact, such as determining if contact has occurred, determining if there is movement of the contact and tracking the movement across the touch screen 115, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 413 and the display controller 412 also detects contact on a touchpad.

Text/graphics module 111 includes various known software components for rendering and displaying graphics on the touch screen 115, including components for changing the intensity of graphics that are displayed. As used herein, the term “graphics” includes any object that can be displayed to a user, including without limitation text, web pages, icons (such as user-interface objects including soft keys), digital images, videos, animations and the like. Additionally, soft keyboards may be provided for entering text in various applications requiring text input. GPS module 112 determines the location of the device and provides this information for use in various applications. Applications 114 may include various modules, including address books/contact list, email, instant messaging, video conferencing, media player, widgets, instant messaging, camera/image management, and the like. Examples of other applications include word processing applications, JAVA-enabled applications, encryption, digital rights management, voice recognition, and voice replication.

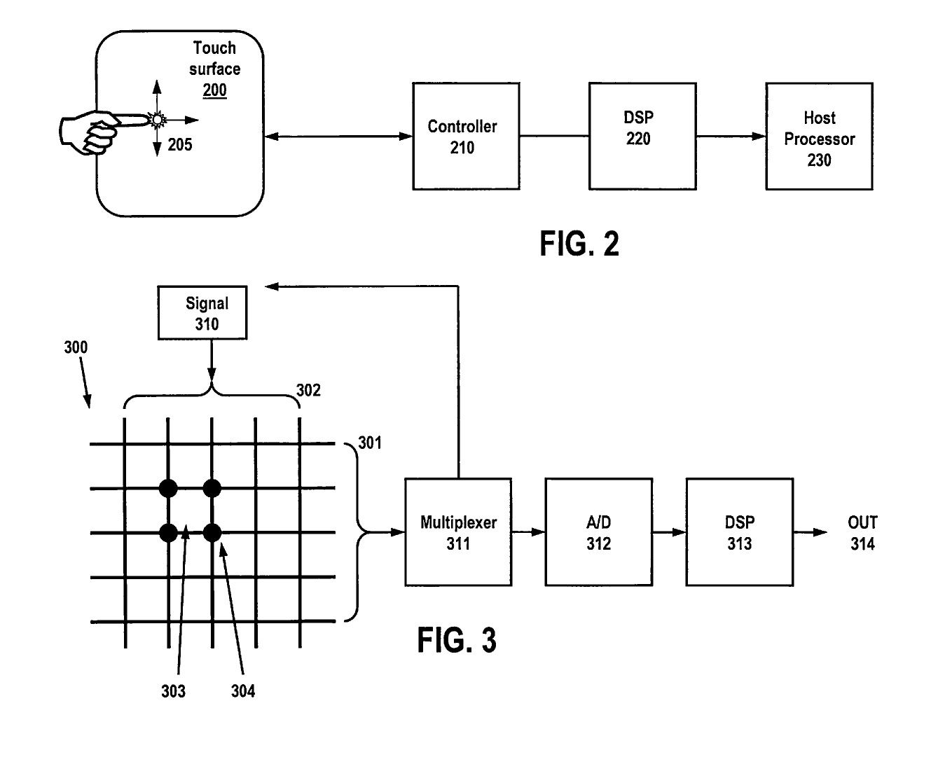

The device(s) disclosed herein are preferably embodied with a touch screen that senses physical contact on one area of the device. FIG. 2 illustrates a configuration for registering one or more areas of contact 205 (also known as “multi-touch”) on touch screen 200 having an integrated touch screen sensor. For the purposes of simplicity, the disclosure pertaining to FIGS. 1-3 will refer to a capacitive touch screen configuration. However, it is understood by those skilled in the art that the principles described below are equally applicable to other touch screen configurations, such as resistive touch screens, infrared, optical, and Surface Acoustic Wave (SAW) technology. As can be seen from FIG. 2, touch screen 200 is configured to detect contact with the touch screen surface that is operatively coupled to sensor on the touch screen. Under one embodiment, touch screen panel 200 includes an insulator such as glass, coated with a transparent conductor such as Indium Tin Oxide (ITO). As is shown in FIGS. 2A-B touching the surface of the screen by a human finger (which is also an electrical conductor) results in a distortion of the screen's electrostatic field, measurable as a change in capacitance. Accordingly, a small amount of charge is drawn to the point of contact. Circuitry located at each corner of the panel (not shown) measures the charge and location, and sends the information to controller 210 for processing.

Under a surface capacitance configuration, only one side of the insulator is coated with a conductive layer, and a small voltage is applied to the layer, resulting in a uniform electrostatic field. When a conductor, such as a human finger, touches the uncoated surface, a capacitor is dynamically formed. The sensor's controller can determine the location of the touch indirectly from the change in the capacitance as measured from the four corners of the panel. Under a Projected Capacitice Touch (PCT) configuration, an X-Y grid is formed either by etching a single layer to form a grid pattern of electrodes, or by etching two separate, perpendicular layers of conductive material with parallel lines or tracks to form the grid. A finger on a grid of conductive traces changes the capacitance of the nearest traces, wherein the change in capacitance is measured and used to determine finger position. In a simplified form, the capacitance may be expressed as

$$C = \frac{ɛ A}{d}$$

where ∈ is the dielectric constant, A is the area and d is the distance. Accordingly, the larger the trace area (A) exposed to a finger, the larger the signal. Also, the smaller the distance d between the finger and the sensor, the larger the signal will be. Thus, the size of the signal (or change of capacitance on the sensor) due to finger contact will be proportional to the overlapping area between the finger and the sensor.

Generally speaking, since capacitive touch screen sensors provide a ratio between voltage and charge, capacitance may be measured by (a) applying known voltages on the sensor and measuring the resulting charge, or (b) imposing a known charge on the sensor and measuring the resulting voltage. Other methods, such as measuring the complex impedance of the sensor, may be used as well. Controller 210 takes information from the touch screen sensor and translates it for further digital signal processing (DSP) 220 to present it in a usable form for host processor 230. Changes in capacitance are translated into electronic signals that are converted to digital representations for processing in DSP 220, where signals from the sensors are converted into finger coordinates, gesture recognition, and so on. Additionally, DSP 220 is preferably configured to perform signal conditioning, smoothing and filtering, and contains the algorithmic processes for determining finger location, pressure, tracking and gesture interpretation.

Turning now to FIG. 3, an exemplary illustration of a touch sensor 300 is provided. Sensor 300 comprises drive lines 302 and sense lines 301 arranged in a perpendicular fashion, where voltage from signal source 310 provides capacitive nodes 303 at the intersection of each sense line 301. It should be noted that the term “lines” as used herein refers to conductive pathways, as one skilled in the art will readily understand, and is not limited to structures that are strictly linear, but includes pathways that change direction, and includes pathways of different size, shape, materials, etc. Drive lines 302 may be driven by stimulation signals from signal source 210, and resulting sense signals generated in sense lines 301 can be transmitted. In this way, drive lines and sense lines can be part of the touch sensing circuitry that can interact to form capacitive sensing nodes, which can be thought of as touch picture elements (touch pixels), such as the one shown in 304. After touch controller (110) has determined whether a touch has been detected at each touch pixel in the touch screen, the pattern of touch pixels in the touch screen at which a touch occurred can be thought of as an “image” of touch (e.g. a pattern of fingers touching the touch screen). When touched 304, capacitance forms between the finger and the sensor grid and the touch location can be computed based on the measured electrical characteristics of the grid layer. The output to multiplexer 311 is an array of capacitance values for each X-Y intersection. Analog-to-digital (A/D) converter 312 converts the multiplexer outputs 311 for DSP 313, which in turn provides an output 314 for use in a computing device. Under a preferred embodiment, signal source 310, multiplexer 311 and A/D converter 312 are arranged in the controller, such as the one illustrated in FIG. 1 (110). Other examples of touch sensors and touch screens may be found in U.S. Pat. No. 7,479,949 titled “Touch Screen Device, Method, and Graphical User Interface for Determining Commands by Applying Heuristics” to Jobs et al., and U.S. Pat. No. 7,859,521 titled “Integrated Touch Screen” to Hotelling et al., each of which are incorporated by reference in their entirety herein.

As mentioned previously, the discussion above was directed to capacitive touch screens, but those skilled in the art would appreciate that other technologies are applicable as well. For example, resistive touch screens have a touch screen controller that connects to a touch overlay comprising a flexible top layer and a rigid bottom layer separated by insulating dots. The inside surface of each of the two layers is coated with a transparent metal oxide coating of ITO that creates a gradient across each layer when voltage is applied. When a finger presses the flexible top sheet, electrical contact is created between the resistive layers, producing a switch closing in the circuit. Voltage is alternated between the layers, and the resulting X-Y touch coordinates are passed to the touch screen controller. The touch screen controller data is then passed on to the computer operating system for processing.

Resistive touch screens may be arranged with 4-wire, 5-wire, and 8-wire resistive overlays. In the case of a 4-wire overlay, both the upper and lower layers in the touch screen are used to determine the X and Y coordinates. The overlay may be constructed with uniform resistive coatings of ITO on the inner sides of the layers and silver buss bars along the edges, where the combination sets up lines of equal potential in both X and Y. During operation, the controller applies a voltage to the back layer. When the screen is touched, the controller probes the voltage with the coversheet, which represents an X-axis left-right position. The controller then applies voltage to the cover sheet probes voltage from the back layer to calculate a Y-axis up-down position. In a 5-wire configuration, one wire goes to the coversheet (which serves as the voltage probe for X and Y), and four wires go to corners of the back glass layer. The controller first applies voltage to corners causing voltage to flow uniformly across the screen from the top to the bottom. When touched, the controller reads the Y voltage from the coversheet. The controller then applies voltage again to the corners and reads the X voltage from the cover sheet.

An infrared touch screen uses an array of X-Y infrared LED and photo detector pairs around the edges of the screen to detect a disruption in the pattern of LED beams. A Surface Acoustic Wave (SAW) touch screen is based on two transducers (transmitting and receiving) placed for the both of X and Y axis on the touch panel, and a reflector is placed on the glass. The controller sends electrical signal to the transmitting transducer, where the transducer converts the signal into ultrasonic waves and emits to reflectors that are lined up along the edge of the panel. After reflectors refract waves to the receiving transducers, the receiving transducer converts the waves into an electrical signal and sends back to the controller. When a finger touches the screen, the waves are absorbed, causing a touch event to be detected at that point.

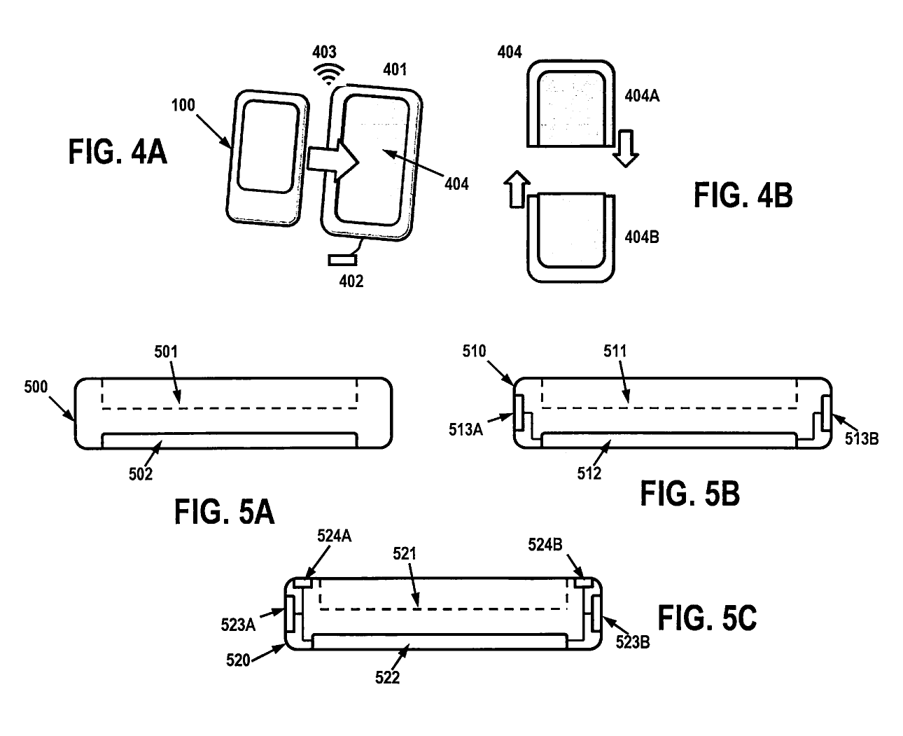

Turning to FIGS. 4A and 4B, exemplary embodiments are disclosed for a grip sensor arrangement 401 configured to encase a portable processing device 100, of the type described above in connection with FIG. 1, and may be a phone, tablet, or the like. In the embodiment of FIG. 4A, grip sensor encasement 401 comprises an opening 404 that may accommodate insertion of device 100. The material of grip sensor encasement 401 may comprise a rigid, semi-rigid, or pliable material, or preferably a combination, that allows relatively easy insertion into opening 404. The material should also be configured to hold and/or encase sensors and grip sensing circuitry for communication with device 100. Additionally, under one embodiment, communications circuitry is provided in grip sensor encasement 401 to transmit and/or receive data to or from device 100 relating to sensor measurements via wired (402) or wireless (403) communications. An alternate embodiment is provided in FIG. 4B, where grip sensor encasement 404 is substantially similar to the embodiment in FIG. 4A, except that the encasement is separated into portions 404A and 404B. In this embodiment, each portion (404A, 404B) may be separated and attached as shown in the arrows of FIG. 4B. Preferably, a locking mechanism incorporating electrodes (not shown, for purposes of brevity) is used to attach each portion to the other, as is known in the art. It is understood by those in the art that other encasement arrangements are possible incorporating one and/or multiple portions.

FIGS. 5A-C provide exemplary embodiments of sensor arrangements for an encasement. FIG. 5A provides one embodiment, where encasement 500 has a opening 501, in which a device may be inserted. On the back side of encasement 500 (i.e., the opposite side of the face or touchscreen of a device) a sensor 502 is positioned to sense gripping over the preferably planar area. In FIG. 5B, sensor 512 is similarly situated on the back side of encasement 510 and opening 511, and is also coupled to side sensors 523A and 523B. In this configuration, touch or grip sensing may be enabled over the back and side planes of enclosure 510. In the embodiment of FIG. 5C, encasement 520 also has opening 521 to accommodate a device, and includes back side sensor 522, side sensors 523A, 523B and top sensors 524A, 524B. In this configuration, touch or grip sensing may be enabled over the back, side, and (partial) top planes of enclosure 520. Any and all of the sensors in FIGS. 5A-C may be extended through to the edges of each side of a enclosure to ensure that the fullest measurements are taken from touches or grips (grasps) of the enclosure.

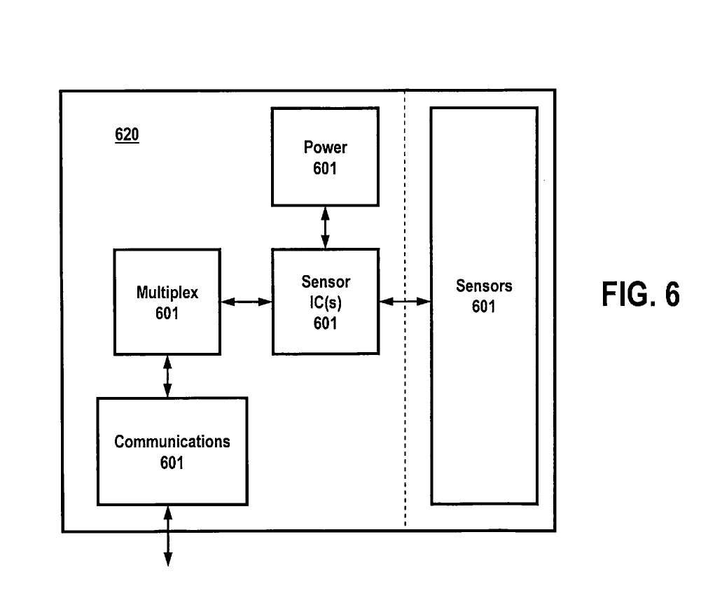

FIG. 6 discloses an exemplary sensor board 620 that is preferably embedded within an encasement, and may also be combined with a sensor, such as a back side sensor, for increased compactness. Sensor board 620 may be configured as a printed circuit board (PCB), FlexPCB, ITO (Indium Tin Oxide), and/or any other suitable material. One or more sensors 601 may be configured as part of sensor board 620 or may separated from the board. Power is provided to sensor board 620 via power supply 601, which is preferably a removable battery. Sensor ICs 601 are preferably multichannel sensor chips that produce independent touch signal values, and may provide these values in absolute values (e.g., 0, 1) or relative values (e.g., 0-255). It is understood by those skilled in the art that the number of channels may vary depending on the number of sensor electrodes used. For example, eight 16-channel ICs may be used to collect data from 128 sensors. In a simpler configuration, eight 8-channel ICs may be used to collect data from 64 sensors.

As data is received from sensors 601, they are forwarded to multiplexer(s) 601 for processing. Depending on the number of channels available in the sensor and electrodes deployed, combinations of electrodes pressed at the same time can be used via multiplexing. Using multiplexing, electrodes may be logically combined to validate touch contact. Once touch/grip contact data is received, it is communicated externally from board 620 via communications 601. Board 620 may be configured as a stand-alone board in an encasement, or may be combined with an additional processor board or mother board, depending on the application. Of course, combining with a processor board may relieve processor power required to process touch/grip senses, but can increase the physical size of the encasement.

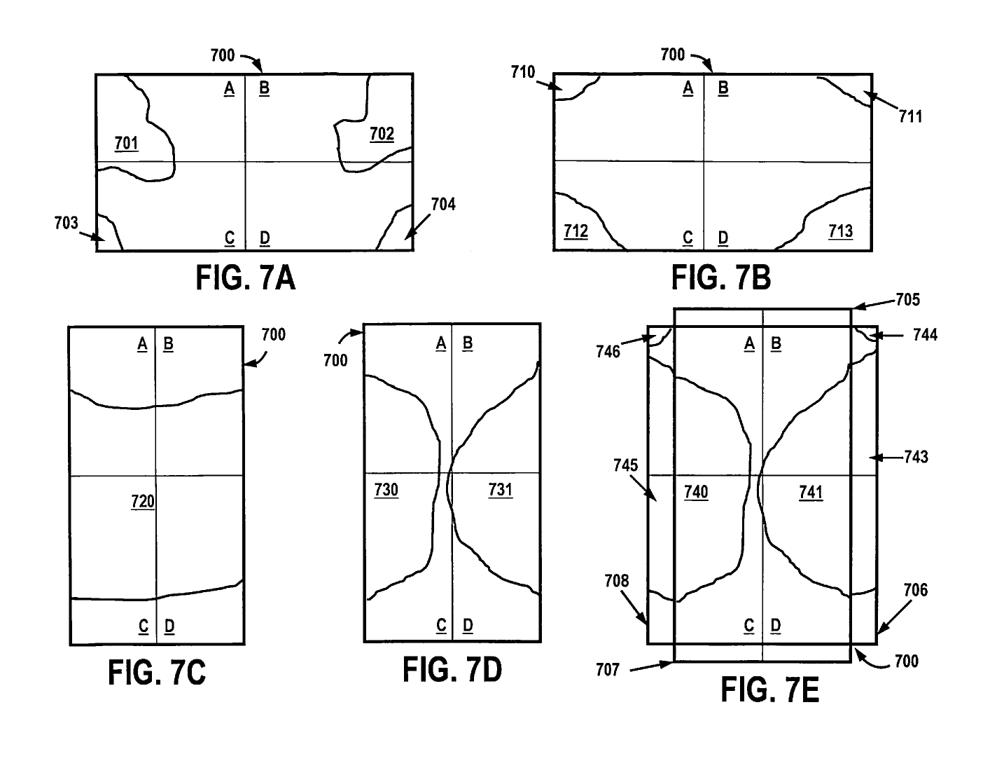

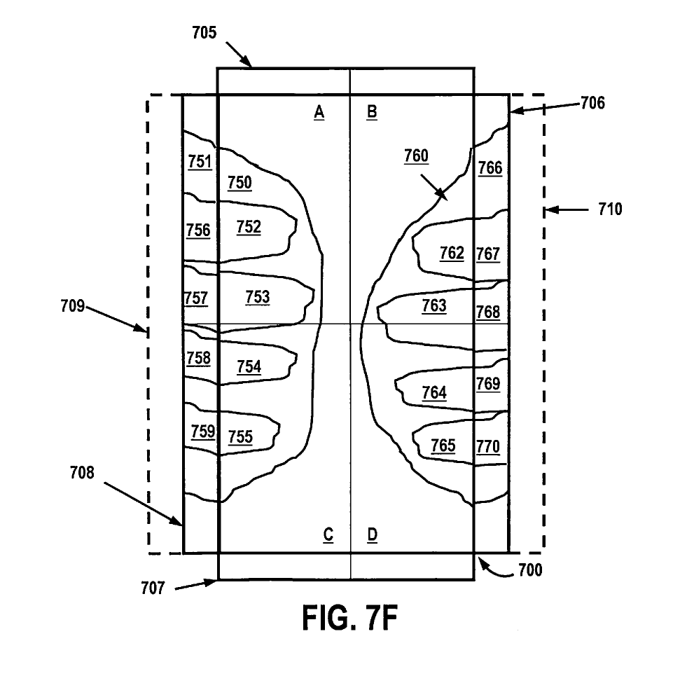

Turning to FIGS. 7A-E, various grip sensing measurements are illustrated. In FIG. 7A, sensor 700 registered four parts of a grip (701-704) at the corners of a device. Here, the device is shown in a sideways configuration, where the sensor 700 area is subdivided into regions A-C as shown. For the purposes of the example, only four regions are shown for purposes of simplicity. It should be understood by those skilled in the art that any suitable number of regions (e.g., 16, 32, 64, etc.) may be used for determining touch/grip sensing in the present disclosure. In the example of FIG. 7A, it can be seen that regions A and B have larger sensed areas 701 and 702 in the corners, while regions C and D have smaller areas 703 and 704 in the other corners. Such a configuration may be indicative of a user watching media and/or texting while a device is being held sideways (i.e., “landscape”).

In FIG. 7B, the sensor readings are similar to 7A, except that the sensed readings in regions A and B (710, 711) are smaller than that in regions C and D (712, 713) and are positioned as shown. The configuration in FIG. 7B may be indicative of a user gripping a portable device in a “camera” mode while the device is being held sideways. In FIG. 7C, sensed reading 720 sweeps across the middle back side of sensor 700, as shown. Here, the sensed readings may be indicative of a phone call mode when a device is held in an upright manner (i.e., “portrait”). FIG. 7D illustrates sensed readings 730 and 731 from sensor 700, as shown. Here, the sensed readings may be indicative of a texting mode when a device is held in an upright manner. FIG. 7E shown another embodiment, where additional sensors (705-708) are incorporated on left/right sides (706, 708) and top/bottom sides (707, 705) as shown. Preferably, sensors 705-708 are arranged to cooperatively sense grip/touch through the three dimensional space enclosed by sensors 700 and 706-708. In this example, it can be seen that the sensed readings 740, 741 appear on sensor 700 and respectively extend through 745, 743 via sensors 708 and 706. Similar to the embodiment of FIG. 7D, the sensed readings may be indicative of a texting mode when a device is held in an upright manner, except that additional readings (743, 745) are obtained from the side sensors 706, 708. Accordingly, a greater amount of data granularity may be obtained for grip/touch sensing. It should be understood by those skilled in the art that the embodiments of FIG. 7A-E are merely a few examples of sensed reading arrangements, and that a myriad of different sensed readings may be obtained. Furthermore, additional sensors may be added to sense grip/touch on at least a top portion of a device, for even greater granularity.

The sensed readings described above may be dependent upon the type, size and number of individual electrodes used for each sensor. In the examples provided above, the sensed readings may be obtained from 8 mm×8 mm electrodes, although other sizes may be suitable as well. Additionally, the level of detail in the sensing may be dependent upon the processing capabilities of sensor IC(s) 601 and multiplex 601. Sensor ICs with higher processing power may be able to sense specific hand grips in a detailed fashion, with the capability of discerning individual finger/hand orientations.

The embodiment of FIG. 7F illustrates a variation of the embodiment of FIG. 7E, where additional sensors 709-710 are added and may be configured to cover a left/right front side of a device, preferably arranged on an opposite side of sensor 700. As explained above, sensors may be arranged to capture absolute and/or relative values. In this example, first values (750, 760) are sensed on sensor 700, as well as first values (751, 766) on sensors 708 and 706. Within these areas, second values (752-759; 762-770) are sensed, which may indicate individual finger orientation. Second values may be obtained via a contact difference from electrodes, i.e., certain contact points having higher sense signal values from others. In the simplified example of FIG. 7F, only two values are illustrated, but it should be understood by those skilled in the art that may values may be obtained from the sensors, resulting in a “grip landscape” measurement involving many pluralities of values. Depending on the application, the sense signal values may also be processed according to sense thresholds to filter and group the sensed contact points. Such a configuration may be advantageous in obtaining a more compact sensing. The sensed signals may thus be arranged according to the number and width of contact points, location of contact points, total width of contact points, area of contact points and distance between contact points to determine a grip.

In order to best categorize different grips, it is preferable that grips be sensed during a training period, where a user would be instructed to hold a device/enclosure during different operations and/or modes. From this, a user's grip profile may be obtained and stored for later comparison. These comparisons may be useful in later determining user identification and device usage. In one advantageous embodiment, contact areas for each region of each sensor are processed to determine a gross contact area (e.g., electrode area, square inches, centimeter, millimeters, etc.). The size, location and orientation of the areas may be individually or collectively processed for grip profile processing purposes. In another embodiment, sub-areas within the gross contact areas, defined by different sensed contact values are processed to determine the size, location and orientation of each sub-area. This configuration provides further detail in determining and/or matching a user grip profile.

Contact signals from sensors may be processed within an enclosure, and/or transmitted to a device (100) via wired or wireless connection, described above, for processing. In one embodiment, contact signals are transmitted to a remote computer or server for processing and recognition matching. The recognition matching process may be done according to a number of techniques that are preferably, but not necessarily based on grouping sensors for each side and accounting for symmetries. Under one technique, grip areas may be compared using a Naïve Bayes classifier, which provides a good trade-off between accuracy and speed of classification/recognition. Generally speaking a Bayesian classier works by assuming that each grip orientation can be represented as a Gaussian distribution in a x-dimension feature space, where each dimension may represent a sensor group. Thus, any way an enclosure is grasped will provide data that corresponds to a point (x), in the feature space. This point can then be input into a discriminant function, fᵢ(x), one function for each grip orientation, according to

fᵢ(x)=½x^{T}Σᵢ⁻¹x+Σᵢ⁻¹μᵢx−½μᵢ^{T}Σᵢ⁻¹μᵢ−½ ln(|μᵢ|)

where x is the vector of the reduced data from a trained grip, μᵢ is a mean for class i, and Σᵢ is a covariance matrix for class i. The discriminant function that returns the highest value is chosen as the most likely orientation for the given grip or grasp.

Under another embodiment, template matching is used by comparing a distance from sensed grip measurements to mean values of different trained classes. In an alternate embodiment, the mean and standard deviations may be calculated for sensors of a grasp; sensed grips that are within limits bounded by an integral multiple of standard deviation are recognized to be matching. In still further embodiments, neural networks may be utilized, e.g., by using a plurality of iterations of randomized, leave N out validation for a number of network nodes. K-Nearest Neighbors may be implemented for a range of K values, each with different tie-breaking algorithms. In still further embodiments, Multicategory Linear Discriminant functions may be implemented for grip classification and recognition.

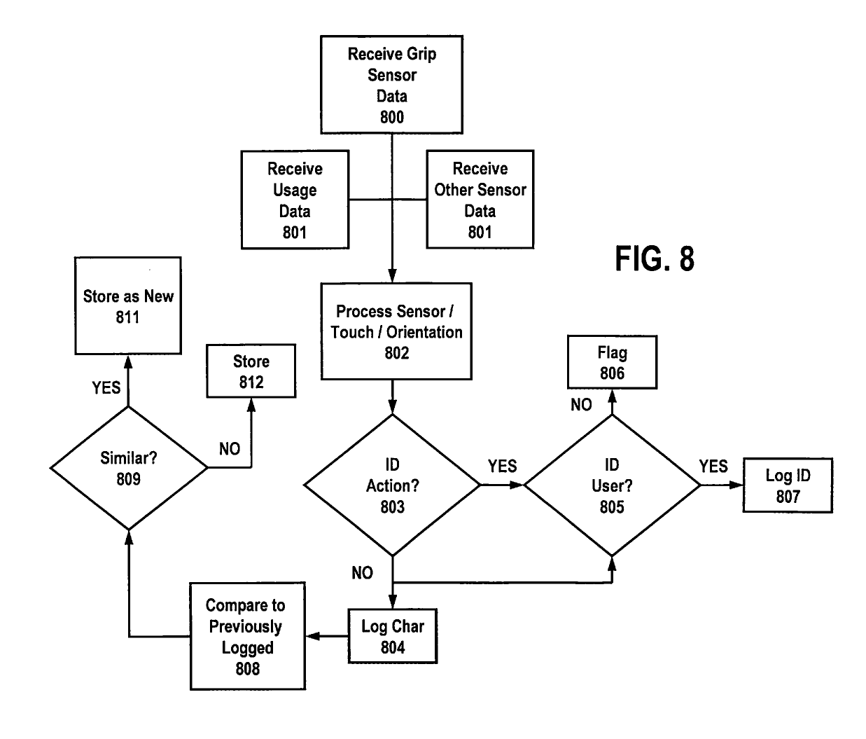

Using any of the techniques described above, it may be possible to recognize types of grips and further recognize users applying the grip to an encasement. As the encasement may be operatively coupled to a portable device, sensed grip/touch measurements may be combined with other sensed measurements (e.g., touch screen, accelerometer) and further linked to media exposure data/research data (e.g., audio signatures, audio codes, Internet usage, application usage). Turning to FIG. 8, an embodiment is illustrated where a device and/or server processes grip sensor data in conjunction with other data to identify a user grip. Here, grip sensor data 800 is received in a manner described in greater detail above. In addition to grip sensor data, other sensor data 801 may be received, such as accelerometer data, device touch screen data, and the like. This data may be used in conjunction with, or even separately from, the grip data to determine device activities and user identification.

Examples of accelerometer data processing is provided in U.S. patent application Ser. No. 13/307,634, titled “Movement/Position Monitoring and Linking to Media Consumption,” filed Nov. 30, 2011, which is assigned to the assignee of the present application and is incorporated by reference in its entirety herein. Here, accelerometer data may be processed to identify a user and link one or more users to media exposure data. Under the present disclosure, grip sensing may be combined with accelerometer data to identify users and user device usage. Examples of touch screen sensing and processing is provided in U.S. patent application Ser. No. 13/307,599, titled “Tactile and Gestational Identification and Linking to Media Consumption,” filed Nov. 30, 2011, which is assigned to the assignee of the present application and is incorporated by reference in its entirety herein. Here, device touch screen senses are processed to identify users and user device usage and link one or more users to media exposure data. Under the present disclosure, grip sensing may be combined with touch screen data to identify users and user device usage.

In addition, device usage data 802 is received, where the usage data relates to operations activated and/or detected on a device (100), along with media exposure data. Media exposure data may include data relating to audio signatures, audio codes, cookies, and any other data indicating device usage characteristics pursuant to the presentation and/or reproduction of media on a device. Exemplary configurations may be found in U.S. Pat. No. 7,627,872 to Hebeler et al., titled “Media Data Usage Measurement and Reporting Systems and Methods” issued Dec. 1, 2009, which is assigned to the assignee of the present application and is incorporated by reference in its entirety here. Media exposure data may also include monitoring of device software usage and/or access, sometimes referred to as “app data.” Examples of such monitoring is described in U.S. patent application Ser. No. 13/001,492, titled “Mobile Terminal And Method For Providing Life Observations And A Related Server Arrangement And Method With Data Analysis, Distribution And Terminal Guiding” filed Mar. 9, 2009, U.S. patent application Ser. No. 13/002,205, titled “System And Method For Behavioural And Contextual Data Analytics,” filed Mar. 8, 2009, and Int'l Pat. Pub. No. WO 2011/161303 titled “Network Server Arrangement For Processing Non-Parametric, Multi-Dimensional Spatial And Temporal Human Behavior Or Technical Observations Measured Pervasively, And Related Method For The Same,” filed Jun. 24, 2010. Each of these documents is incorporated by reference in their entireties herein.

Under one embodiment media exposure data may be collected using media data usage gathering objects. Objects may serve to gather usage data for a single predetermined category of media data, such as graphical data, audio data, streaming media data, video data, text, web pages, image data, and the like. In this manner, each object preprocesses usage data by selecting the data based upon predetermined criteria. In certain embodiments, each object is dedicated to monitoring usage of media data of only one format, such as JPEG image data, AVI data, streaming media data to be reproduced by a certain player type, HTML, documents, BMP image data, etc. Media format may also include one or more techniques used to collect audio codes and/or audio signatures. In certain embodiments, each object is dedicated to monitoring usage of media data presented by means of only one type of user agent, such as a particular browser, player, etc. As new or different data formats and user agents become available, new or different objects and/or object classes may be provided to a processor (101) to enable monitoring thereof. The objects and object classes are preferably received by the processor via a network or other communication medium, or else from a storage medium. The monitoring capabilities are thus updated quickly and efficiently to keep pace with the ongoing, rapid evolution of media data formats and user agents.

In certain embodiments, data gathered by objects may represents media usage events such as the opening or closing of a user agent, a request for or receipt of new or different content or resource control location channel, scrolling, volume change, muting, onclick events, maximizing or minimizing a window, accessing software or apps, an interactive response to received content (such as a submission of a form or order), and/or the like. In other embodiments, an object may poll for predetermined media data state information, such as currently received content or currently accessed resource control location and/or the state of a user agent. Depending on the embodiment, an object may record either changes in state and/or the state itself. In further embodiments, an object may collect content metadata accompanying or associated with the media data. In other embodiments combinations of the foregoing are employed. In certain embodiments the attributes of an object include times or durations of the events or state information.

In certain embodiments an object may gather data at the board level (for example, a sound card 106), while in other embodiments it gathers data at the network level. In still other embodiments it gathers data at the operating system level (109), while in still further embodiments it gathers data at the application level 114 (for example, a player, viewer or other application). In yet still further embodiments, the object may gather data at two or more of the foregoing levels. Processor 101 may instantiate session objects which run within the processor or elsewhere in a user system for merging the media data usage gathering object into a respective session object which gathers data for a respective user session.

In certain embodiments the user session is defined by grouping media data usage gathering objects based on time or duration criteria. In various such embodiments, media data usage gathering objects representing usage (presentation or access) within each of predetermined time periods (such as dayparts or days) are grouped in corresponding user sessions. In other such embodiments, media data usage gathering objects representing one or more continuous and/or overlapping resource control location sessions are grouped in a single user session, while in further such embodiments media data usage gathering objects representing resource control location sessions separated in time by no more than a predetermined period are grouped into a single user session. In still other such embodiments combinations of the foregoing criteria are employed to group the objects into user sessions.

In other embodiments the user session is defined by grouping media data usage gathering objects based on indications of user activity. In various such embodiments, user inputs (for example, by means of a keyboard, keypad, pointing device, dial, remote control or touch screen, or an activity such as the insertion of prerecorded media in a disk drive or the like) are monitored to detect continuing user activity to determine the duration of a user session. In further embodiments, users are asked to indicate the beginning and/or the end of a user session.

In certain embodiments, one or more of the following attributes are included in the session objects: (1) “Session start”: the time that an RCL is first accessed by the user system and the media data is delivered thereto, or else when such media data is first presented to the user; (2) “Session stop”: the time that the user system ceases to access the RCL, or else when presentation of its media data to the user ceases; (3) “Session duration”: the duration of a user session, which may be measured as the length of time between Session start and Session stop; (4) “Session content”: the type and identity of the presented or accessed media data; (5) “Session interaction”: user interaction events occurring during a user session; (6) “Session content events”: media data events occurring during a user session; (7) “Session context”: system events occurring during a user session; (8) “Session metadata”: data describing the user session and any supporting data.

Report objects may be instantiated to merge session objects and/or other objects into itself, and/or to encapsulate data, for supply to one or more reporting systems for producing media usage reports. In certain embodiments, a report object may nerge one or more session objects representing the media data usage of a single user into a corresponding report object, while in others the object merges session objects into a report object representing media data usage by multiple identified users. In certain embodiments a report object may nerge one or more session objects representing media data usage within a predetermined time span, while in other embodiments report object merges session objects in response to a request from a reporting system coupled with user device or system either through the network or via a different communication medium.

Once data 800-802 is received, it is processed in 803 in order to correlate the data, so that usage and exposure data is linked to specific sensor readings, including sensed grip readings. In 804, the sensor readings are processed to identify an action being taken via accelerometer, touch screen, grip sensing, etc. In the case of grip sensing, sensed grip readings are compared to trained grip readings and/or templates that are stored in memory. A first comparison is made to determine whether a user mode may be identified 804. As discussed above, user modes may include such modes as texting, phone call, camera, media watching, etc., and may additionally provide device orientation as well. In addition to grip sensing, data from usage data 802 and other sensor data 801 may be used to confirm device usage. As one example, a data gathering object on a device may record the opening of a phone app at the time a grip was sensed. The sensed grip reading may then be confirmed as being associated with a particular mode relating to the app. In another example, a data gathering object may record the opening of a web page at a time during which a grip was sensed. The sensed grip reading may then be confirmed as being linked to a viewing mode associated with the web page. In yet another example, audio signatures are detected contemporaneously with a sensed grip reading. The sensed grip reading may then be linked to a listening mode associated with a user listening to audio. In yet another embodiment, screen taps on a device are sensed together with a sensed grip reading, which may indicate and/or confirm a user was in a texting mode during a sensed grip reading. In yet another embodiment, accelerometer readings may be combined with sensed grip readings, to determine/confirm that a device was in a particular orientation (e.g., upright, sideways, skewed, etc.) at the time of grip sensing.

If a mode is identified in 804, another comparison is made to see if a user may be identified in 806. The comparison may be made using any of the techniques described above. If the user is positively identified, the identification is logged in 809. If the user cannot be identified, the sensed grip is flagged, together with a time of sensing, and also any other associated data from 801-802. It can be appreciated that the grip sensing may be a valuable tool in identifying users. It can be further appreciated that grip sensing may also be used to determine duplicate use of devices as well, which is an important feature in the audience measurement realm. In this case, sensed grip readings may be compared to a global trained database to determine if one user has physical possession of another device. In order to ease and/or simplify the number of trained readings, the comparisons may be done to a predetermined group of people that are initially identified through a registration process (e.g., friends, family, co-workers). Alternately, comparisons may be made against registered users in a geographic location.

It can be seen from FIG. 8 that if mode identification 804 cannot be determined under the first comparison, the second user identification comparison 806 may nevertheless be carried out. In certain circumstances, the training data for mode identification may be different from the training data for user identification, in which case a user may be identified without identifying a user/device mode. It is understood by those skilled in the art that steps 804 and 806 may be done in reverse order as well, i.e., user identification is performed first, then mode identification. Each may be also be performed individually, as needs require.

In step 805, if a mode identification (and/or user identification) cannot be determined, the sensed grip readings a logged and stored for the device. As unidentified readings are accumulated, they may be stored in a separate database. As new unidentified readings are recorded, they may be compared to previously logged readings 809. If this comparison shows a match or similarity in 810, the previously unidentified grip reading is stored as a new reading in 812, meaning that a new mode has been determined. If no similarities are found, the reading is stored in 811 for later use in step 809. In the case of user identification, the similarity in 810 may indicate that a different (or unauthorized) user has grasped the device multiple times. Under a preferred embodiment, the device may challenge the user to provide authentication information, such as a password, or call in number. Alternately, an option may be provided for a new user to register with the device, which in turn would register the device as a multi-user device for an audience measurement entity.

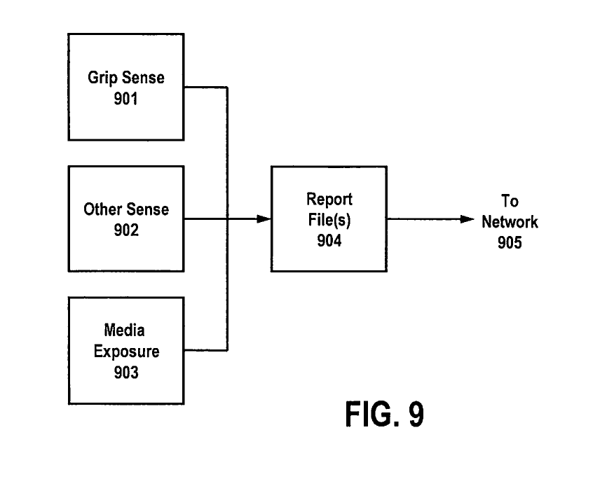

It can be seen that the grip sensing described above may be valuable for audience measurement purposes, and may be incorporated in media exposure reports. In the embodiment of FIG. 9, it can be seen that sensed grip readings 901, other sensor readings 902 and media exposure data 903 may be associated and compiled into a reporting file 904, which may be processed locally or transmitted to a network 906, such as the Internet, or telecommunications network. While the compilation and generation of reports in 904 may be done locally on a user device, it may be the case that a particular device has limited processing power. In such a case, the data from 901-903 is transmitted remotely to a computer processing device, such as a server, for reporting.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method for processing sensor data for the purposes of audience measurement, comprising the steps of:
receiving in a processing device first sensor data, said first sensor data comprising grip data relating to contact with a first sensor associated with a portable device;
receiving in the processing device media exposure data, said media exposure data representing media received or reproduced on the portable device; and
processing the first sensor data to determine a characteristic of the grip data, wherein the characteristic relates to a manner in which the first sensor was grasped.

2. The computer-implemented method of claim 1, wherein the characteristic comprises a mode of usage for the portable device.

3. The computer-implemented method of claim 1, wherein the characteristic comprises grip data associated with a specific user.

4. The computer-implemented method of claim 3, further comprising the step of validating the grip data associated with the specific user.

5. The computer-implemented method of claim 5, wherein the validating step comprises comparing the grip data to previously stored grip data.

6. The computer-implemented method of claim 1, further comprising the step of:
receiving in the processor device second sensor data, said second sensor data comprising data relating to at least one of (1) touch screen data and (2) accelerometer data.

7. The computer-implemented method of claim 1, wherein the media exposure data comprises at least one of ancillary codes from audio, audio signatures, metadata, software data and application data.

7. The computer-implemented method of claim 1, wherein the media exposure data is associated with the first sensor data.

8. The computer-implemented method of claim 1, wherein the first sensor comprises an enclosure configured to be operatively coupled to the portable device.

9. The computer-implemented method of claim 1, wherein the first sensor data and media exposure data is processed to generate a report, configured to be transmitted remotely to a processing station.

10. A system for processing sensor data in a portable device for the purposes of audience measurement, comprising:
a processor;
a first sensor, operatively coupled to the processor, the first sensor being configured to produce first sensor data, said first sensor data comprising grip data relating to contact with the first sensor associated with the portable device;
wherein the processor is configured to produce media exposure data, said media exposure data representing media received or reproduced on the portable device; and
wherein the processor is configured to process the first sensor data to determine a characteristic of the grip data, wherein the characteristic relates to a manner in which the first sensor was grasped.

11. The system of claim 10, wherein the characteristic comprises a mode of usage for the portable device.

12. The system of claim 10, wherein the characteristic comprises grip data associated with a specific user.

13. The system of claim 12, wherein the processor is configured to validate the grip data associated with the specific user.

14. The system of claim 13, wherein the processor validation comprises comparing the grip data to previously stored grip data.

15. The system of claim 10, further comprising a second sensor configured to produce second sensor data and operatively coupled to the processor, wherein the processor is configured to process the second sensor data, said second sensor data comprising data relating to at least one of (1) touch screen data and (2) accelerometer data.

16. The system of claim 10, wherein the media exposure data comprises at least one of ancillary codes from audio, audio signatures, metadata, software data and application data.

17. The system of claim 10, wherein the processor is configured to associate media exposure data with the first sensor data.

18. The system of claim 10, wherein the first sensor comprises an enclosure configured to be operatively coupled to the portable device.

19. The system of claim 10, wherein the first sensor data and media exposure data is transmitted remotely for report generation.
